(19) United States
(12) Patent Application Publication
(10) Pub. No.: US 2003/0092392 A1
(43) Pub. Date: May 15, 2003

(54) Weighted wireless early detection

(76) Inventors: Sridhar Komandur, Richardson, TX (US); Janet H. Lind, Plano, TX (US)

Correspondence Address: R. Scott Rhoades, Strasburger & Price, L.L.P., Suite 4300, 901 Main Street, Dallas, TX, 75202-3794, US

(21) Appl. No.: 10/289,613

(22) Filed: Nov. 7, 2002

Related U.S. Application Data
(60) Provisional application No. 60/345,035, filed on Nov. 9, 2001.

(51) Int. Cl. H04B 17/00

(52) U.S. Cl. 455/67.1; 455/39

(57) ABSTRACT

A system and method for controlling the transmission of data packets is presented herein. A wireless content switch is placed in a wireless packet data network and receives signals indicating whether the wireless clients are experiencing conditions indicative of losing data packets. Wherein the foregoing conditions are detected, the wireless content switch controls the transmission rate of further data packets by reducing a window size parameter in an acknowledgment signal transmitted by the wireless client. The window size can be reduced progressively, either on a linear or exponential basis.

### CROSS-REFERENCE TO RELATED APPLICATIONS

This application claims the priority benefit of U.S. Provisional Application for Patent, Serial No. 60/345,035, entitled “Weighted Wireless Early Detection,” filed on Nov. 9, 2001, which is hereby incorporated by reference for all purposes.

### STATEMENT REGARDING FEDERALLY SPONSORED RESEARCH/DEVELOPMENT

Not Applicable.

### FIELD

The present application is directed to wireless packet data networks, and more particularly to improvement of throughput in wireless packet data networks.

### BACKGROUND

Wireless networks are increasingly used for accessing the Internet. Wireless packet data protocols such as the Universal Mobile Telecommunications System (UMTS) and General Packet Radio Services (GPRS) were developed to facilitate the transmission of data packets over the wireless network.

The Internet is a global network connecting computers from government agencies, education institutions, the military, and business from around the world. Data is transmitted over the Internet using data packets. The data packets are sent from a sender to a recipient over any one of a number of networks connections between the sender and recipient. Unlike a switched network, no dedicated connection between the sender and recipient is established. In contrast, the packets are sent from the sender with an address associated with the recipient, such as an Internet Protocol address (IP Address) over any one of a number of available paths between the sender and recipient by the Internet.

Due to the lack of a dedicated path between the recipient and the sender, the requisite time of transmission can vary from packet to packet. Additionally, during periods of congestion, data packets can also be dropped by an intermediate router. The foregoing considerations necessitate a means of providing the sender with a confirmation that the transmitted data packets are received. The Transmission Control Protocol (TCP) provides for the user of acknowledgment messages between the recipient and the sender, responsive to receipt of a data packet.

TCP adjusts the rate of transmission of data packets by ramping up the transmission rate in a sliding window at the beginning of a packet flow, which is called the slow start mode. After reaching a threshold on the sliding window size, TCP slowly increases the transmission rate in a linear fashion, which is called the congestion-avoidance mode. However, when packets are not received within a predetermined time period, TCP assumes that the packets are lost due to network congestion. In wired networks, which are characterized by low bit error rate, the assumption is accurate. However, wireless networks are characterized by comparatively higher bit error rates, limited bandwidth, radio interference, and intermittent handoffs result in more packet losses. The higher bit error rate, radio interference, and intermittent handoffs result in more packet losses. The assumption that packet losses are due to congestion becomes inaccurate in wireless networks. Additionally, the foregoing conditions have a tendency to be temporary and in short duration.

In the presence of the high bit error rates and intermittent connectivity characteristic of wireless links, TCP reacts to packet losses in the same manner as in the wired environment. The transmission window size is sharply lowered before retransmitting packets and congestion control and avoidance mechanisms are invoked. The foregoing mechanisms result in an unnecessary reduction in the wireless link's bandwidth utilization, given the short tendency and duration of conditions causing high bit error rates and low throughput.

Additionally, the wireless link in a network is usually characterized with a comparatively lower throughput rate. Therefore, data packets can be transmitted at a faster rate to the wireless link than over the wireless link. The foregoing results in a backlog of data packets accumulating for transmission over the wireless link. The backlog of data packets are alleviated in part by storage in a buffer memory.

The amount of data packets that can be stored in the buffer memory is limited by the size of the buffer memory. When the buffer memory is completely consumed, additional data packets are dropped. The buffer memory stores the data packet backlog for any number of wireless clients. As a result, the amount of data packets that can be stored for each wireless client is also limited by the number of wireless clients served.

Accordingly, it is desirable to restrict the amount of buffer memory that is consumed for storage of data packets for each wireless client.

It would also be advantageous if the degradation due to congestion control mechanisms could be alleviated.

### SUMMARY

Presented herein is a system, and method for controlling the transmission of data packets in a wireless packet data network. A wireless content switch detects conditions at wireless clients which are indicative of losing data packets and reduces the window size in data packet acknowledgments. The foregoing reduction in window size can be progressive on both a linear and exponential basis.

### BRIEF DESCRIPTION OF THE DRAWINGS

FIG. 1 is a block diagram of a communication network;

FIG. 2 is a signal flow diagram describing the operation of the communication network;

FIG. 3 is a block diagram of a communication network supporting General Packet Radio Services;

FIG. 4 is a block diagram of an exemplary wireless content switch; and

FIG. 5 is a flow diagram describing the operation of the wireless content switch.

### DETAILED DESCRIPTION OF THE DRAWINGS

In the descriptions which follow, like parts are marked throughout the specification and drawings with the same numerals, respectively. The drawing figures are not necessarily drawn to scale and certain figures may be shown in exaggerated or generalized form in the interest of clarity and conciseness.

Referring now to FIG. 1, there is illustrated a block diagram of a communication network, referenced generally by the numeric designation 100, for transmitting data to a wireless client 105 from a content source 110. The wireless client 105 is a mobile terminal generally associated with a user or subscriber to the wireless network 120, and can comprises, but is not limited to, a mobile station, a personal digital assistant, a lap top computer, or a palm top computer capable of engaging in wireless data communications.

The content source 110 is a server computer which can include, for example, a web server. The content source 110 is generally connected to a wired network 115. The wired network 115 can comprise, for example, a local area network, a wide area network, or the Internet.

The wired network 115 is interfaced with a wireless network 120 associated with the wireless client 105. The wireless network 120 is often a cellular telephone network which is adapted to provide packet data services, such as he Global System for Mobile Telecommunications (GSM). The wireless network 120 communicates with the wireless client 105 over the wireless air interface. The content source 110 transmits data to the wireless client 105 through a series of data packets. The data packets are transmitted over the wired network 115 to the wireless network 120. The wireless network 120 then transmits the data packets to the wireless client 105 over a wireless link over the air interface.

The wired network 115 is characterized by low bit error rates and loss of a data packet in the wired network 115 is usually due to network congestion. However, the air interface between the wireless client 105 and the wireless network 120 is characterized by comparatively higher bit error rates, limited bandwidth, radio interference, regions of poor radio communications (known as “dead zones”), and intermittent handoffs due to mobility. The higher bit error rates, radio interference, and intermittent handoffs are major causes for packet losses in contrast to congestion.

Upon detection of lost data packets, the content source 110 drastically reduces the transmission rate of further data packets. The transmission rate is then ramped up over time. The foregoing is known as slow start. The slow start results in a significant throughput reduction for a period of time. The slow start is effective in preventing congestion deadlock in the communication network. However, the lossy nature of the wireless link results in packet losses due to temporary conditions. The slow start unnecessarily reduces throughput in response to detection of lost packets due to such temporary conditions.

A wireless content switch 125 detects conditions for the wireless client 105 which are indicative of losing data packets, prior to the loss of the data packets. Conditions which are indicative of data packet losses can include, for example, detection of deterioration in the radio frequency wireless link, or detection of excessive buffer memory usage by a wireless client. Upon detection conditions which are indicative of losing data packets, the wireless content switch 125 causes the content source 110 to reduce the transmission rate of the data packets thereby preventing loss of packet data. The reduction of the transmission rate of the data packet can be controlled to be considerably less drastic than the reduction associated with the slow start. In one exemplary embodiment, the wireless content switch 125 is an Intelligent Packet Control Node (IPCN) developed and manufactured by Cyneta Networks, Inc.

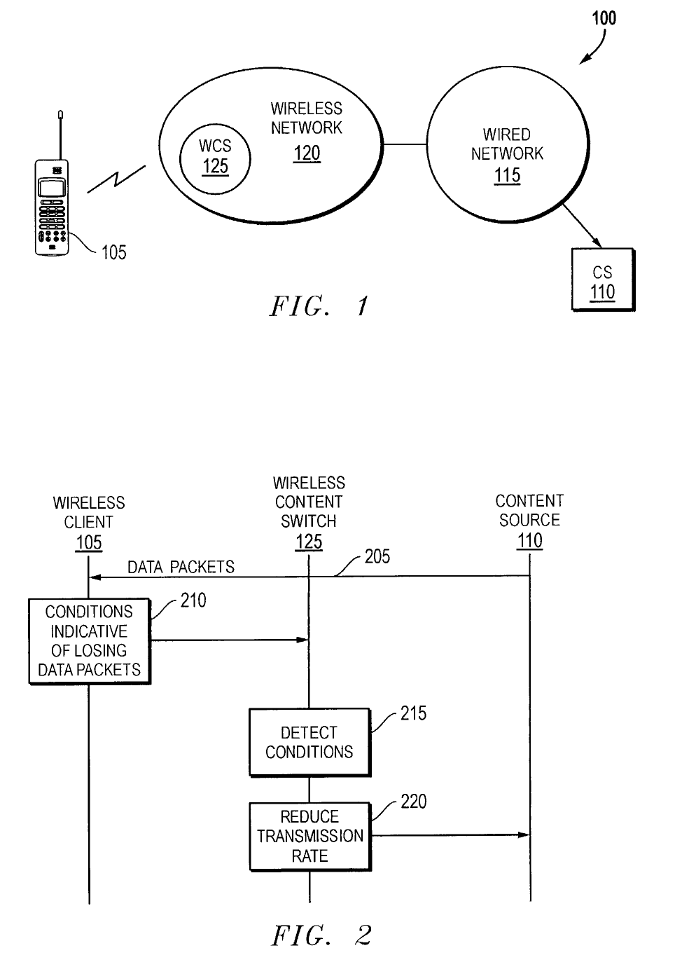

Referring now to FIG. 2, there is illustrated a signal flow diagram describing the operation of the communication network. The content source 110 transmits data to the wireless client 105 (signal 205). During transmission of the data packets to the content source 105, conditions indicative of losing data packets arise with respect to the wireless client 105 (action 210). The conditions can be, for example, deterioration of the wireless link because of radio interference, dead zones, or handoffs, or overconsumption of buffer memory by the wireless client 105. When the conditions indicative of losing data packets arise, the wireless content switch 125 detects the foregoing (action 215) and reduces the transmission rate at the content source 110 (action 220). The foregoing reduction in the transmission rate can be considerably less drastic and at a rate that is more appropriate for the existing wireless link condition. Additionally, the transmission rate at the content source 110 can be controlled to result in a gradual reduction.

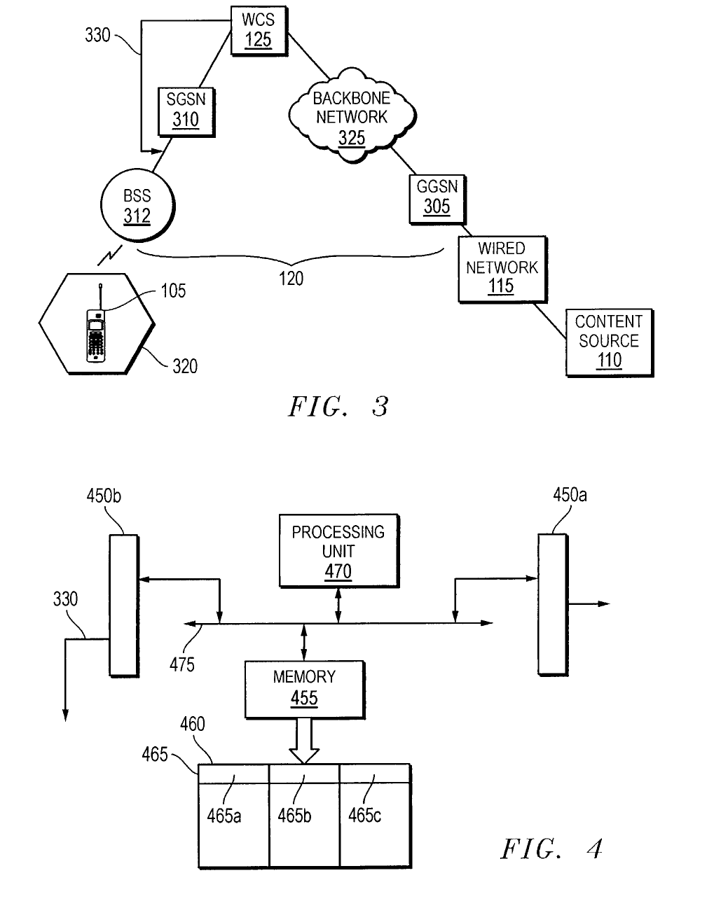

Referring now to FIG. 3, there is illustrated a block diagram of an exemplary communication network configured to support General Packet Radio Services (GPRS). Pursuant to GPRS specifications, the wireless networks 120 is interfaced with the wired networks 115 by any number of Gateway GPRS Support Nodes (GGSNs) 305. Each GGSN 305 is associated with any number of IP addresses which the GGSN 305, in turn, allocates to wireless clients 105.

The wireless network 120 provides packet data services to geographical areas which are divided into routing areas. Each routing area is associated with a particular Serving GPRS Support Node (SGSN) 310. Each SGSN 310 is associated with any number of base station systems 312. The base station systems 312 include the radio transceiver equipment that transmits and receives signals to and from the wireless client 105. Base station systems 312 maintain radio frequency communications within a geographic area known as a cell 320.

The SGSN 310 and the GGSNs 305 are interconnected by a backbone network 325. The backbone network is a network that routes packet data between the SGSNs 310 and the GGSNs 305. During transmission from the content server 110 to the wireless client 105, the content server 110 transmits the data packets to an IP address associated with the GGSN 315. The GGSN 315 receives the data packet, determines the identity and location of the wireless client 105 associated with the IP address. After determining the location of the wireless client 105, the GGSN 315 determines the SGSN 310 associated with the cell containing the wireless client 105 and forwards the packets to the wireless client 105 over the backbone network 325. The interface between the SGSNs 310 and the GGSNs 315 is known as the Gn interface.

A wireless content switch 125 is associated with each SGSN 310 and receives all signals transmitted and received thereat. The wireless content switches 125 are placed between the SGSN 310 and the backbone network 325. Additionally, a probe 330 extends from the wireless content switch 125 to the interface between the base stations systems 312 and the SGSN 310. The foregoing interface is known as the Gb interface. In the foregoing manner, the wireless content switch 125 can receives all signals that are received at and transmitted from the SGSN 310 on both, the Gb and Gn interfaces. The signals received by the SGSN 310 include signals which are indicative, among other things, of conditions where data packets for a wireless client 105 may be lost.

The conditions indicative of losing data packets can be detected in a variety of ways. For example, the wireless content switch 125 can determine the quality of the wireless link by receiving the radio status message from the wireless client 105. The radio status message is indicative of the quality of the wireless link. Wherein the radio status message indicates that the quality of the wireless link is below a certain predetermined quality, the wireless content switch 125 detects that the throughput rate is lower.

Alternatively, the wireless content switch 125 can monitor the data packets that are received at the SGSN 310 for a particular wireless client 105 and the data packets that are transmitted from the SGSN 310 for the wireless client 105 to determine the proportion of a buffer at the SGSN 310 allocated for the wireless client 105 which is available.

Those skilled in the art will recognize that the wireless link between the base station system 312 and the wireless client 105 has the lowest throughput in the communication network. Therefore, data packets can be transmitted from the content server 110 to the base station system 312 at faster rate than the data packets from the base station system 312 to the wireless client 105. The foregoing results in a backlog of data packets accumulating in the wireless network. The backlog of data packets are alleviated in part by allocation of a buffer memory at the SGSN 310 to store the data packets. The SGSN 310 includes memory which is divided and allocated to each of the active wireless clients 105 served by the SGSN 310.

The wireless content switch 125 can determine the proportion of the buffer memory allocated to the wireless client 105 which is consumed by estimating the buffer size, and monitoring the amount of data packets which are received at the SGSN 310 and the amount of data packets which are transmitted from the SGSN 310. The buffer size can be estimated by dividing the total memory at the SGSN 310 by the number of active wireless client 105 served by the SGSN 310. Additionally, proportional weights can be applied for certain wireless clients 105, depending on subscribed level of service, wherein certain wireless clients 105 may be permitted higher amounts of memory than other wireless clients. The amount of data packets that are received at the SGSN 310 can be determined by monitoring the amount of data packets which are received at the wireless content switch 125. The amount of data packets that are transmitted from the SGSN 310 can be determined by measuring the data packets which are received at the probe 330. The foregoing is described in greater detail in “System, Method, and Apparatus for Preventing Data Packet Overflow at Node in Wireless Packet Data Services Network”, U.S. patent application Ser. No. 09/915,010, filed Jul. 25, 2001, which is hereby incorporated by reference for all purposes. The wireless content switch 125 can determine whether the throughput rate is not suitable for the transmission rate based on the amount of the buffer memory allocated to the wireless client 105 which is consumed.

Upon detecting conditions indicative of losing data packets, the wireless content switch 125 causes the content source to reduce the rate of transmission of data packets. The wireless content switch 125 can reduce the rate of transmission of data packets by receiving an acknowledgment of a data packet from the wireless client 105 and reducing the window size. In one embodiment, the window size can be reduced linearly, each successive time that the wireless client 105 is experiencing conditions indicative of losing data packets. Alternatively, the window size can be reduced exponentially, each successive time that the wireless client is experiencing conditions indicative of losing data packets.

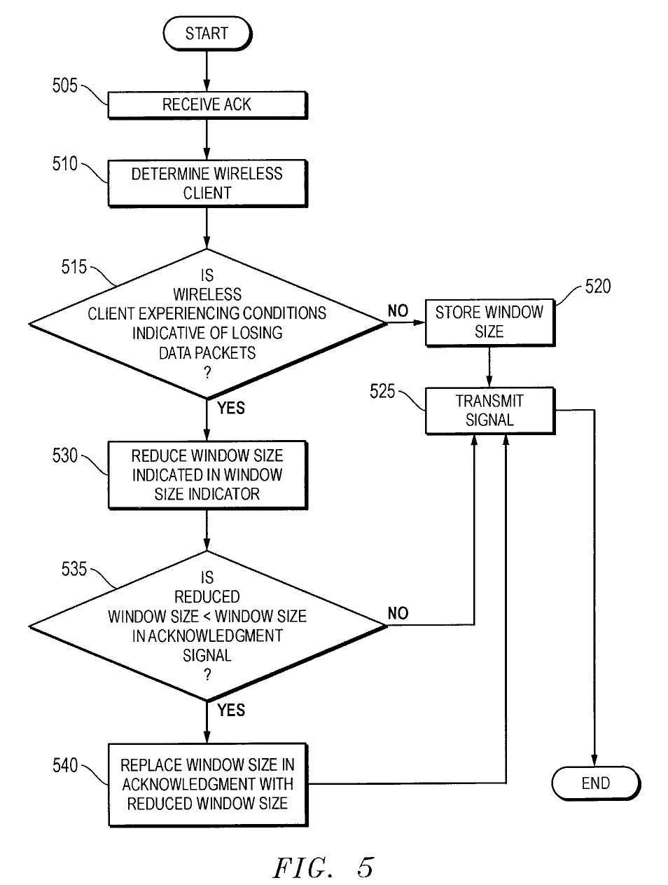

Referring now to FIG. 4, there is illustrated a block diagram of an exemplary wireless content switch 125. The wireless content switch 125 includes any number of upstream ports 450a and downstream ports 450b. The upstream ports 450a facilitate connection of the wireless content switch 125 towards the content server 110 via a data transport mechanism, such as, for example, a T1, E1, or an Ethernet connection, to name a few. Connection of the wireless content switch 125 towards the content server 110 via the upstream port 450a permits, at the upstream port 450a, receipt and transmission of data packets, acknowledgments, and other signals to and from content server 110.

Similarly, the downstream ports 450b facilitate connection of the wireless content switch 125 towards the wireless client 105 via a data transport mechanism. Connection of the wireless content switch 125 towards the wireless client 105 and base station systems 312 via the downstream port 450b permits, at the downstream port, receipt of control signals to and from the wireless client 105. In an exemplary embodiment, the upstream ports 450a can facilitate connection to the SGSN 310. Additionally, a particular one of the downstream ports 450b can be used to connection the wireless content switch 125 via a probe to a connection between the base station system 312 and the SGSN 310. Accordingly, the wireless content switch 125 can receive messages transmitted between the base station and the SGSN 310 that carries the wireless link information.

The wireless content switch 125 also includes memory 455 for storage of a wireless client table 460. The wireless client table 460 includes any number of records 465, wherein each of the records 465 is associated with a particular wireless client 105. The records 465 include a wireless client identifier 465a for storing an identifier of the wireless client associated with the record and a lost packet condition indicator 465b for storing an indicator indicating whether the wireless client associated with the record is experiencing conditions indicative of losing data packets, and a window size indicator 465c for storing the most recent window size for the wireless client. The memory can also store executable instructions for execution by a processing unit 470. The processing unit 470, memory 455, upstream ports 450a, and downstream ports 450b are interconnected by a bus 475.

The wireless content switch 125 is capable of receiving signals which indicate whether the wireless client 105 is experiencing conditions indicative of losing data packets. Wherein signal(s) indicating conditions indicative of losing data packets for the wireless client 105 are received, the wireless content switch 125 sets the lost packet condition indicator 465b to indicate that the wireless client 105 is experiencing conditions indicative of losing data packets. Additionally, the wireless content switch 125 receives acknowledgment signals from the wireless clients 105 acknowledging receipt of the data packets that were received at the wireless client 105. The acknowledgment signals include a parameter known as a window size that indicates the amount of data available at a buffer at the wireless client 105. The wireless content switch 125 determines the identity of the wireless client 105 transmitting the acknowledgment signal, and determines whether the wireless client 105 is experiencing conditions indicative of losing data packets by examining the lost data packet condition indicator 465b of the record associated with the wireless client 105. Wherein the lost data packet condition indicator 465b does not indicate conditions at the wireless client 105 which are indicative of losing data packets, the wireless content switch 125 stores the window size in the window size indicator 465c.

Wherein the lost data packet condition indicator 465b indicates that the wireless client 105 is experiencing conditions indicative of losing data packets, the wireless content switch 125 reduces the window size. The window size can be reduced in accordance with a number of different schemes. In one scheme, the window scheme can be reduced by a predetermined amount. In another scheme, the window size can be progressively reduced on an iterative basis. For each consecutive acknowledgment that the wireless client 105 is experiencing conditions indicative of losing data packets, the wireless content switch 125 progressively reduces the window size. The progressive reduction can either be linearly by a predetermined amount during each iteration or exponentially by a predetermine proportion during each iteration.

To facilitate progressive reduction, the window size for the wireless client 105 is stored at the window size indicator 465c of the record associated with the wireless client 105. Therefore, wherein the window size is to be progressively reduced, the window size that is stored in the window size indicator 465c is progressively reduced and stored. The reduced window size in the window size indicator 465c is compared to the window size in the acknowledgment signal. Wherein the reduced window size is smaller than the window size in the signal, the window size in the signal is replaced with the reduced window size.

The wireless content switch 125 is discussed further in U.S. patent application Ser. No. 09/839,830 entitled “System and Method for Wireless Packet Data Content Switch,” which is commonly owned and assigned with the present application and in U.S. patent application Ser. No. 09/884,663 entitled “Packet Retransmission in Wireless Packet Data Networks,” which is commonly owned and assigned with the present application and both of which are hereby incorporated by reference.

Referring now to FIG. 5, there is illustrated a flow diagram describing the operation of the wireless content switch 125 responsive to receiving an acknowledgment (step 505). Responsive to receiving the acknowledgment, the wireless content switch 125 determines the identity of the wireless client 105 transmitting the acknowledgment (step 510). Upon determining the identity of the wireless client 105 transmitting the acknowledgment, the wireless content switch 125 determines whether the wireless client 105 is experiencing conditions indicative of losing data packets (step 515) by examining the lost data packet condition indicator 465b of the record associated with the wireless client 105.

Wherein the wireless client 105 is not experiencing conditions indicative of losing data packets, the wireless content switch 125, stores the window size contained in the acknowledgment signal in the window size indicator 465c of the record associated with the wireless client 105 (step 520), and transmits the acknowledgment signal (step 525).

Wherein the wireless client 105 is experiencing conditions indicative of losing data packets during step 515, the window size contained in the window size indicator 465c is reduced (step 530). The reduced window size in then compared to the window size in the acknowledgment signal (step 535). Wherein the window size in the acknowledgment signal is smaller, the acknowledgment signal is transmitted (step 525) with the original window size. Wherein the reduced window size in the window size indicator 465c is smaller, the window size in the acknowledgment signal is replaced with the reduced window size (step 540), and transmitted with the acknowledgment (step 525).

Although the foregoing detailed description describes certain embodiments with a degree of specificity, it should be noted that the foregoing embodiments are by way of example, and are subject to modifications, substitutions, or alterations without departing from the spirit and scope of the invention. Accordingly, the invention is only limited by the following claims, and equivalents, thereof.

What is claimed is:

1. A method for transmitting data packets in a wireless packet data network, the method comprising:
detecting conditions indicative of losing data packets associated with the wireless client; and
reducing transmission rate at a content source responsive to detecting conditions indicative of losing data packets associated with the wireless client.

2. The method of claim 1, wherein reducing the transmission rate at the content source further comprises:
transmitting a first signal to the content source, the signal comprising a first window size, wherein the first window size is lower than a second window size transmitted in a second signal to the content source immediately prior to the first signal.

3. The method of claim 1, wherein reducing the transmission rate further comprises:
exponentially reducing the window size.

4. The method of claim 1, wherein detecting conditions indicative of losing data packets further comprises:
estimating buffer availability for the wireless client.

5. The method of claim 4, wherein estimating buffer availability for the wireless client further comprises:
estimating buffer size for the wireless client;
estimating a proportion of the buffer size which is used.

6. The method of claim 1, wherein detecting conditions indicative of losing data packets associated with the wireless client further comprises:
receiving a signal comprising a radio quality parameter; and
detecting lower throughput wherein the radio quality parameter is lower than a predetermined threshold.

7. A wireless content switch for controlling data packet transmission to wireless clients, the wireless content switch comprising:
a first one or more ports for receiving signals acknowledging receipt of data packets, the signals acknowledging receipt of the data packets including a first window size parameter;
a processor coupled to the first one or more ports, the processor for replacing the first window size parameter of the received signals with a second window size parameter, the second window size parameter smaller than the first window size parameter; and
a second one or more ports for transmitting signals acknowledging receipt of data packets, the signals acknowledging receipt of the data including the second window size parameter.

8. The wireless content switch of claim 7 further comprising:
memory for storing a plurality of records, each of the plurality of records associated with a particular wireless client, and each of the records further comprising:
an indicator for storing an identifier indicating whether the wireless client associated with record is experiencing conditions indicative of losing data packets.

9. The wireless content switch of claim 8, wherein the second one or more ports transmit the signal including the second window size, wherein the indicator of a record associated with the wireless client transmitting the first signals indicates that the wireless client is experiencing conditions indicative of losing data packets.

10. The wireless content switch of claim 8, wherein each record further comprises:
a window size indicator for storing an indicator indicating the first window size.

11. A method for controlling the transmission of data packets, the method comprising:
receiving an acknowledgment from a particular wireless client, the acknowledgment including a first window size;
identifying the particular wireless client;
determining whether the particular wireless client is experiencing conditions indicative of losing data packets; and
transmitting the acknowledgment with a second window size, wherein the particular wireless client is experiencing conditions indicative of losing data packets.

12. The method of claim 11, wherein the step of transmitting the acknowledgement with a second window size includes transmitting the acknowledgement with a second window size smaller than the first window size.

13. The method of claim 12, wherein the step of transmitting the acknowledgement with a second window size smaller than the first window size includes transmitting the acknowledgement with a second window size exponentially smaller than the first window size.

14. The method of claim 12, wherein the step of transmitting the acknowledgement with a second window size smaller than the first window size includes transmitting the acknowledgement with a second window size linearly smaller than the first window size.

15. The method of claim 11, wherein the step of determining whether the particular wireless client is experiencing conditions indicative of losing data packets include evaluating a radio status message from the wireless client.

16. The method of claim 11, wherein the step of determining whether the particular wireless client is experiencing conditions indicative of losing data packets include monitoring data packets and buffer memory utilization.
